(19) United States
(12) Patent Application Publication
(10) Pub. No.: US 2005/0273463 A1
(43) Pub. Date: Dec. 8, 2005

(54) System for calculating client sessions information

(76) Inventors: Meir Zohar, Givat Shmuel (IL); Nir Zisso, Kfar Saba (IL)

Correspondence Address: DANIEL J SWIRSKY, PO BOX 2345, BEIT SHEMESH, 99544, IL

(21) Appl. No.: 10/861,904

(22) Filed: Jun. 7, 2004

(51) Int. Cl. G06F 17/30

(52) U.S. Cl. 707/7

(57) ABSTRACT

A multi-browser history aggregation system is provided including a client computer, a web browser with which the client is operative to selectively retrieve a web page from a server, where the browser is operative to monitor any interaction between the client and the server and store a description of the interaction in an interaction store, a categorizer operative to associate the interaction with a category and store the category information in the interaction store, and a transmitter operative to transmit previously stored interaction descriptions from the interaction store to an aggregator.

### FIELD OF THE INVENTION

The present invention relates to internet browser client in general, and more particularly to the calculation of measures of client web site browsing behavior.

### BACKGROUND OF THE INVENTION

The Internet's vast array of web sites and enormous pools of information have the capability of overwhelming a typical web surfer. While each web site may attempt to cater its services to a specific clientele, a web surfer interested in a particular set of services has no way of knowing in advance which web site will provide the services he is interested in. Search engines, such as yahoo™, provide one mechanism to enable web surfers to limit and focus their browsing to a subset of websites. The information available on the web is organized and typically categorized by the search engines and stored on the search engine's web server. Unfortunately, this reliance on search engines limits a web surfer's choices to web sites monitored by the search engine and requires the web surfer to accept the search engine's categorization of web sites. Web sites that are not known to a search engine or not categorized in a way that the web surfer expects may never be found.

### SUMMARY OF THE INVENTION

In one aspect of the present invention a multi-browser history aggregation system is provided including a client computer, a web browser with which the client is operative to selectively retrieve a web page from a server, where the browser is operative to monitor any interaction between the client and the server and store a description of the interaction in an interaction store, a categorizer operative to associate the interaction with a category and store the category information in the interaction store, and a transmitter operative to transmit previously stored interaction descriptions from the interaction store to an aggregator.

In another aspect of the present invention the system further includes a summarizer operative to summarize the retrieved interaction descriptions.

In another aspect of the present invention the transmitter is operative to transmit the summarized information to the aggregator.

In another aspect of the present invention the aggregator is operative to rank the summarized information and store the ranking in a ranking database by category.

In another aspect of the present invention the categorizer is operative to categorize by employing a predefined mapping of potential interactions with interaction categories.

In another aspect of the present invention the system further includes an updater operative to periodically retrieve the information stored in the ranking database, and store the retrieved ranking information on the client in a priority store.

In another aspect of the present invention the updater is operative to verify that the contents of the ranking database on the aggregator are different than the contents of the priority store, whereupon the updater retrieves the information stored in the ranking database.

In another aspect of the present invention the updater is operative to retrieve the latest version of the ranking database.

In another aspect of the present invention the system further includes an assistant operative to monitor behavior of the browser, and search the priority store for any entries in a category that corresponds to that of the monitored behavior.

In another aspect of the present invention the assistant is operative to provide an alert where an entry is found in the priority store that corresponds to that of the monitored behavior.

In another aspect of the present invention the assistant is operative to provide the alert by changing the content of a button bar assistant visible in the browser.

In another aspect of the present invention the assistant is operative to provide the alert by displaying a description of the found entry category appear on a button bar assistant visible in the browser.

In another aspect of the present invention the assistant is operative, responsive to a user pressing the button bar assistant, to retrieve the entry from the priority store from the same category as that of the currently monitored behavior, and display the retrieved entry.

In another aspect of the present invention the assistant is operative to display the retrieved entry's URL and rank.

In another aspect of the present invention the browser includes an interaction monitor operative to monitor the interaction between the client and the server and transmit to an interaction server the description of the interaction.

In another aspect of the present invention the interaction server is operative to receive concurrent transmissions from a plurality of the interaction monitors.

In another aspect of the present invention the interaction monitor is operative to identify any of its transmissions by including an identifier in any of its transmissions to the interaction server, where the identifier uniquely identifies either of the interaction monitor the browser.

In another aspect of the present invention the system further includes a browser session manager operative to analyze information received from the interaction monitor and detect the creation and destruction of a virtual browser session.

In another aspect of the present invention the browser session manager is operative to record a virtual browser session to the interaction store, and where either of the summarizer and the transmitter is operative to create an interaction session during which information related to the client's interaction with the server is gathered.

In another aspect of the present invention the browser session manager includes a session queue operative to create an entry in an event list corresponding to the virtual browser session, the entry corresponding to the information received by the interaction server.

In another aspect of the present invention the browser session manager is operative to destroy the session, whereupon the session queue is operative to store the event list and its corresponding entries associated with the session in the interaction store.

In another aspect of the present invention a multi-browser history aggregation method is provided including monitoring any interaction between a client and a server, storing a description of the interaction in an interaction store, associating the interaction with a category, storing the category information in the interaction store, and transmitting previously stored interaction descriptions from the interaction store to an aggregator.

In another aspect of the present invention the method further includes summarizing the retrieved interaction descriptions.

In another aspect of the present invention the transmitting step includes transmitting the summarized information to the aggregator.

In another aspect of the present invention the method further includes ranking the summarized information and storing the ranking in a ranking database by category.

In another aspect of the present invention the associating step includes categorizing by employing a predefined mapping of potential interactions with interaction categories.

In another aspect of the present invention the method further includes periodically retrieving the information stored in the ranking database, and storing the retrieved ranking information on the client in a priority store.

In another aspect of the present invention the method further includes verifying that the contents of the ranking database on the aggregator are different than the contents of the priority store, and, if so, retrieving the information stored in the ranking database.

In another aspect of the present invention the method further includes retrieving the latest version of the ranking database.

In another aspect of the present invention the method further includes monitoring behavior of the client, and searching the priority store for any entries in a category that corresponds to that of the monitored behavior.

In another aspect of the present invention the method further includes providing an alert where an entry is found in the priority store that corresponds to that of the monitored behavior.

In another aspect of the present invention the method further includes providing the alert by changing the content of a button bar assistant visible in the browser.

In another aspect of the present invention the method further includes providing the alert by displaying a description of the found entry category appear on a button bar assistant visible in the browser.

In another aspect of the present invention the method further includes retrieving, responsive to a user pressing the button bar assistant, the entry from the priority store from the same category as that of the currently monitored behavior, and displaying the retrieved entry.

In another aspect of the present invention the displaying step includes displaying the retrieved entry's URL and rank.

In another aspect of the present invention the method further includes monitoring the interaction between the client and the server and transmitting to an interaction server the description of the interaction.

In another aspect of the present invention the method further includes receiving concurrent transmissions from a plurality of the interaction monitors.

In another aspect of the present invention the method further includes identifying any of its transmissions by including an identifier in any of its transmissions to the interaction server, where the identifier uniquely identifies either of an interaction monitor and a browser.

In another aspect of the present invention the method further includes detecting the creation and destruction of a virtual browser session.

In another aspect of the present invention the method further includes recording a virtual browser session to the interaction store, and creating an interaction session during which information related to the client's interaction with the server is gathered.

In another aspect of the present invention the method further includes creating an entry in an event list corresponding to the virtual browser session, the entry corresponding to the information received by the interaction server.

In another aspect of the present invention the method further includes destroying the session and storing the event list and its corresponding entries associated with the session in the interaction store.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a multi-browser history aggregation system, constructed and operative in accordance with a preferred embodiment of the present invention;

FIG. 1B is a simplified flow chart illustration of a method for summation of client browsing, operative in accordance with a preferred embodiment of the present invention;

FIG. 1C is a simplified pictorial illustration of an alternative multi-browser history aggregation system, constructed and operative in accordance with a preferred embodiment of the present invention;

FIG. 2, which is a simplified pictorial illustration of a system of aggregation and distribution to clients of summarized information, constructed and operative in accordance with a preferred embodiment of the present invention;

FIG. 3A, which is a simplified pictorial illustration of a browsing client assistant, constructed and operative in accordance with a preferred embodiment of the present invention;

FIG. 3B, which is a simplified pictorial illustration of a browser display with a button bar assistant, constructed and operative in accordance with a preferred embodiment of the present invention;

FIG. 3C, which is a simplified flow chart illustration of a method for providing assistance to a client browsing, operative in accordance with a preferred embodiment of the present invention;

FIG. 4A, which is a simplified block-flow illustration of a browser interaction monitor, constructed and operative in accordance with a preferred embodiment of the present invention;

FIG. 4B, which is a simplified block-flow illustration of an aggregator with an interaction server, constructed and operative in accordance with a preferred embodiment of the present invention;

FIG. 5 is a simplified block-flow illustration of a virtual browser session, constructed and operative in accordance with a preferred embodiment of the present invention; and

FIG. 6A through 6D, taken together, are simplified block diagrams of an example session queue, constructed and operative in accordance with a preferred embodiment of the present invention.

### DETAILED DESCRIPTION OF PREFERRED EMBODIMENTS

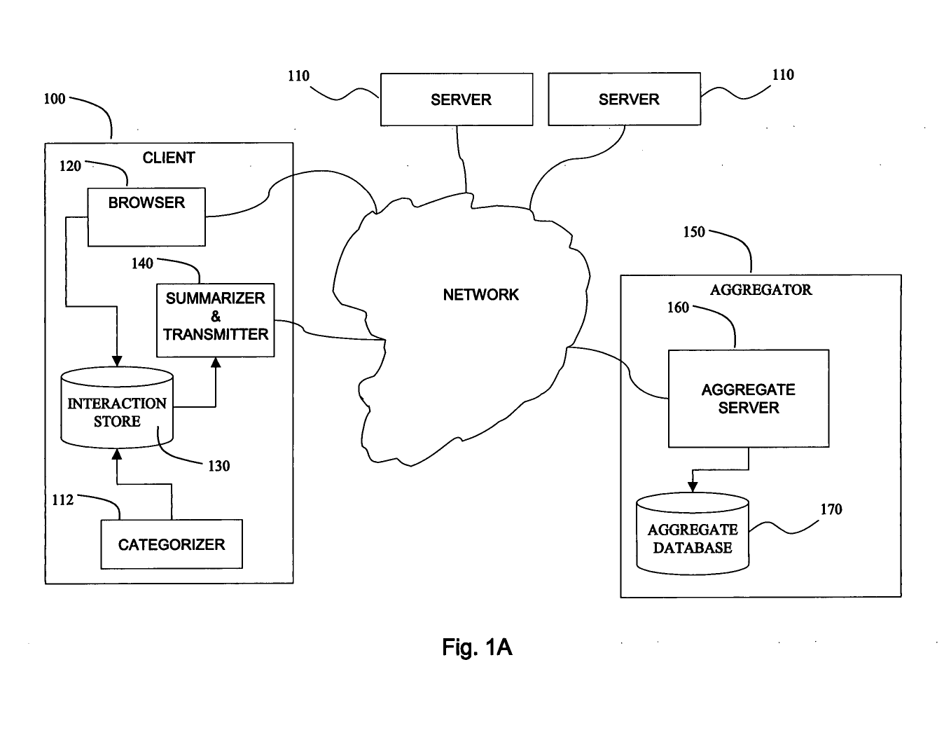

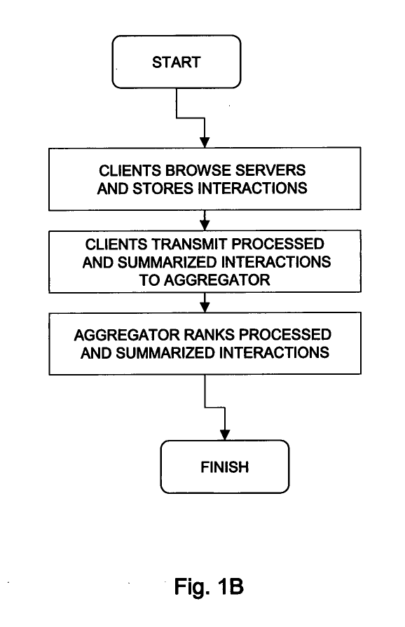

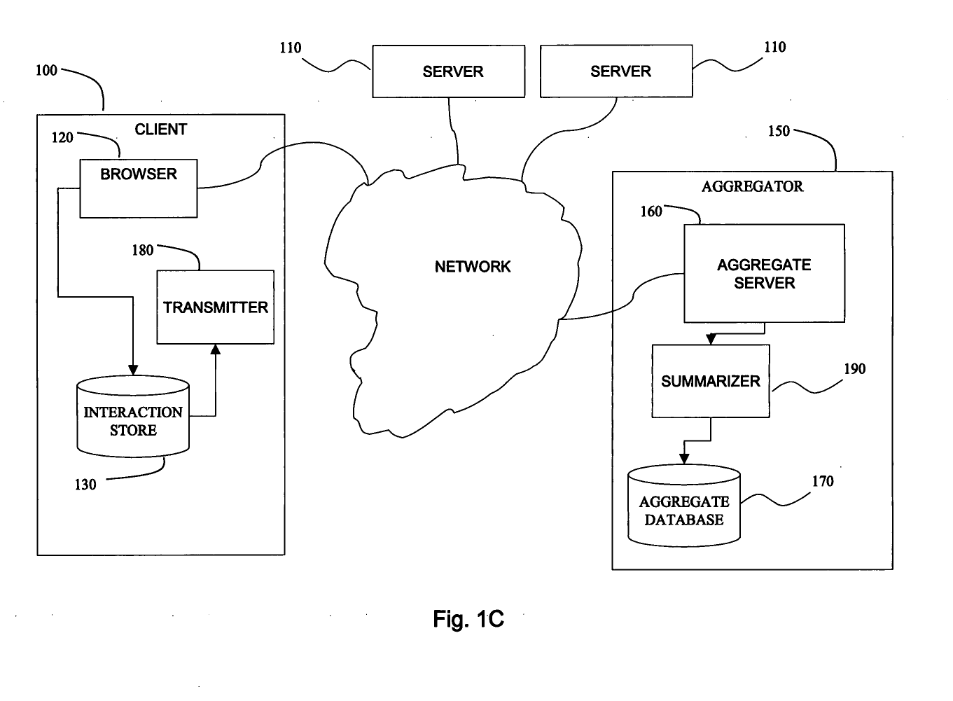

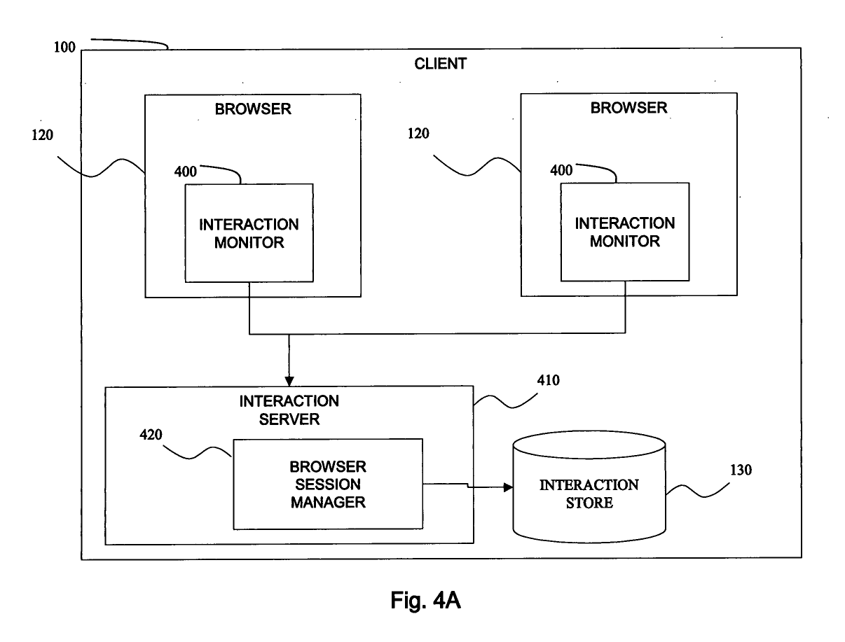

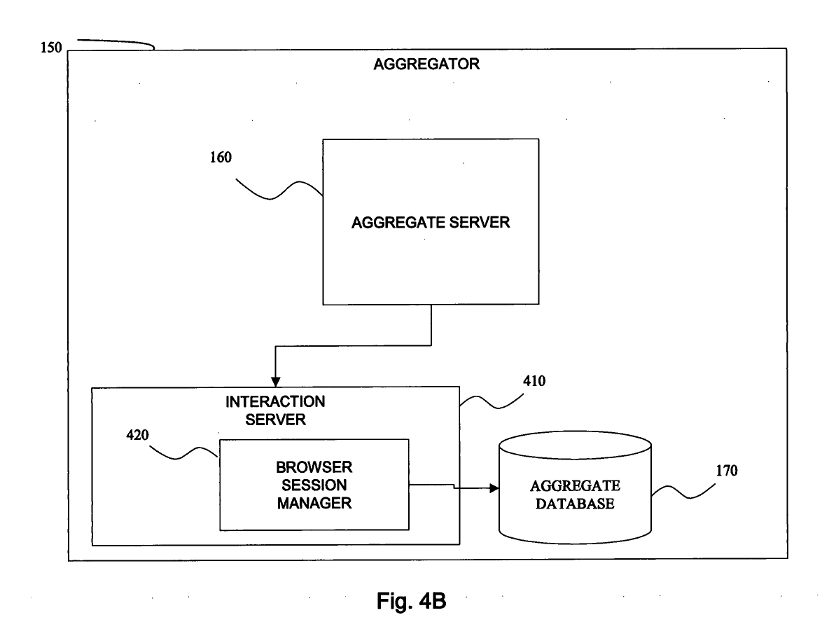

Reference is now made to FIG. 1A, which is a simplified pictorial illustration of a multi-browser history aggregation system, and to FIG. 1B, which is a simplified flow chart illustration of a method for summation of client browsing, operative in accordance with a preferred embodiment of the present invention. One or more client computers 100 typically connect to one or more servers 110, such as web servers, in sequence or concurrently over a network, such as the Internet. The sequence, duration and other such particulars of the interaction between an individual client 110 and a server 110 may be unknown to other clients 110. Similarly, the gathering of information at an individual server 110 is typically unknown at different servers 110 and clients 100. Client 100 may, with browser 120, selectively browse or ‘web surf’ web pages on servers 110. Browser 120 preferably monitors any, and preferably all, interactions between client 100 and server 110 and stores a description of the monitored interactions in an interaction store 130, described in greater detail hereinbelow with reference to FIG. 4A. Preferably, client 100 includes a categorizer 112 which associates each interaction with a category, such as by employing a predefined mapping of potential interactions with interaction categories, and inserts category information into the information stored in interaction store 130. For example, should a user ‘web surf’ to a URL, such as ‘yahoo.com/news’, the categorizer will insert into interaction store 130 a categorization of the URL, such as ‘NEWS’.

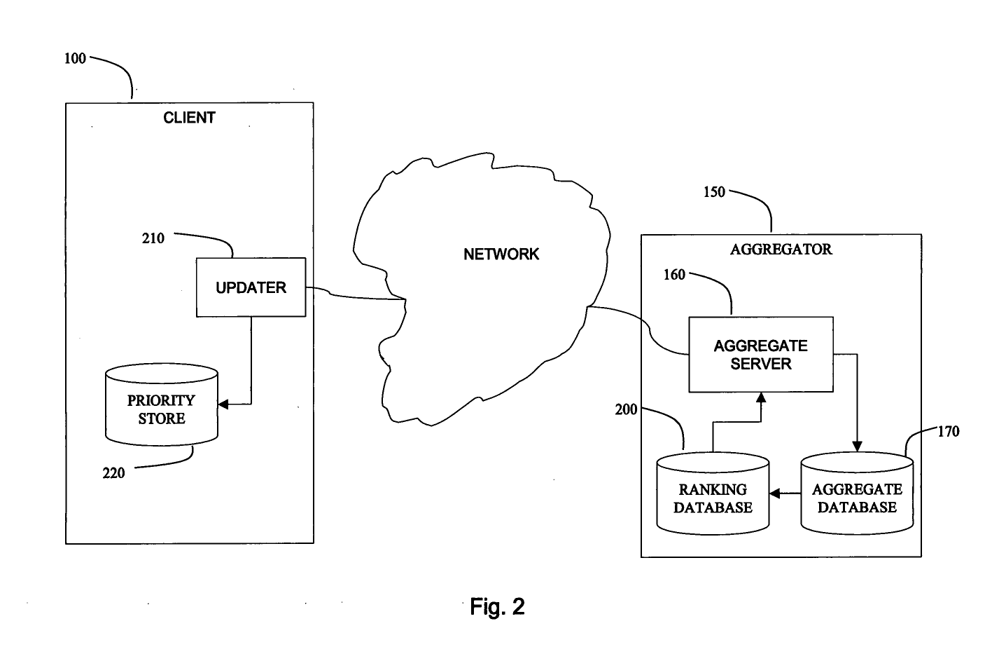

Typically independent of the browsing of client 100, a summarizer & transmitter 140 periodically retrieves, such as once a day, previously stored interaction descriptions from interaction store 130. Summarizer & transmitter 140 preferably processes the records of the interactions as described hereinbelow with reference to FIG. 4A, and typically transmits the processed and summarized information to an aggregator 150, described in greater detail hereinbelow with reference to FIG. 2. Aggregator 150 may employ an aggregate server 160 to receive the processed and summarized information and store the information in an aggregate database 170.

Reference is now made to FIG. 1C, which is a simplified pictorial illustration of an alternative multi-browser history aggregation system, operative in accordance with a preferred embodiment of the present invention. The system of FIG. 1C may be understood as an alternative to the system of FIG. 1A and is substantially similar to the system of FIG. 1A, with the notable exception that the functionality of summarize & transmitter 140 is divided between the client 100 and the aggregator 150. In the system of FIG. 1C, a transmitter 180 transmits interactions previously stored in the interaction store 130 to the aggregator 150 where a summarizer 190 continues the processing of the records of the interactions, as described in more detail hereinbelow with reference to FIG. 4B.

Reference is now made to FIG. 2, which is a simplified pictorial illustration of a system of aggregation and distribution to clients of summarized information, constructed and operative in accordance with a preferred embodiment of the present invention. Aggregator 150 may employ aggregate server 160 to receive the processed and summarized information from clients 100. Aggregator 150 may then organize and rank the information received from clients 100. Any known ranking method may be used, such as where URLs are ranked by the amount of time users spend at a web site. The ranked information is preferably stored in a ranking database 200 by category for future retrieval by clients 100.

Typically, client 100 will employ an updater 210 to periodically retrieve the information stored in ranking database 200 and store a local version of ranking database 200 on client 100 in a priority store 210. In one methodology, updater 190 may first query aggregate server 160 to verify that the version of ranking database 200 available on aggregator 150 is indeed different than the version stored locally on client 100 in priority store 210, whereupon updater 210 retrieves the information stored in ranking database 200. Alternatively, updater 190 may receive the latest version of ranking database 200 using any other known mechanism, such as a ‘push’ mechanism initiated by aggregate server 160, as is well known in the art.

Priority store 210 preferably includes a categorized list of URL's that include ranking information. For example priority store 210 may contain the following XML content:

<category id=4000>

<child name=YahooNews url=yahoo.com/news rank=4 description=“ap news site”/>
<child name=MsnNews url=msn.com/news rank=2 description=“microsoft news site”/>
   </category>
   <category id=4100>
<child name=SearchMe url=google.com rank=1 description=“content search engine”/>
   </category>

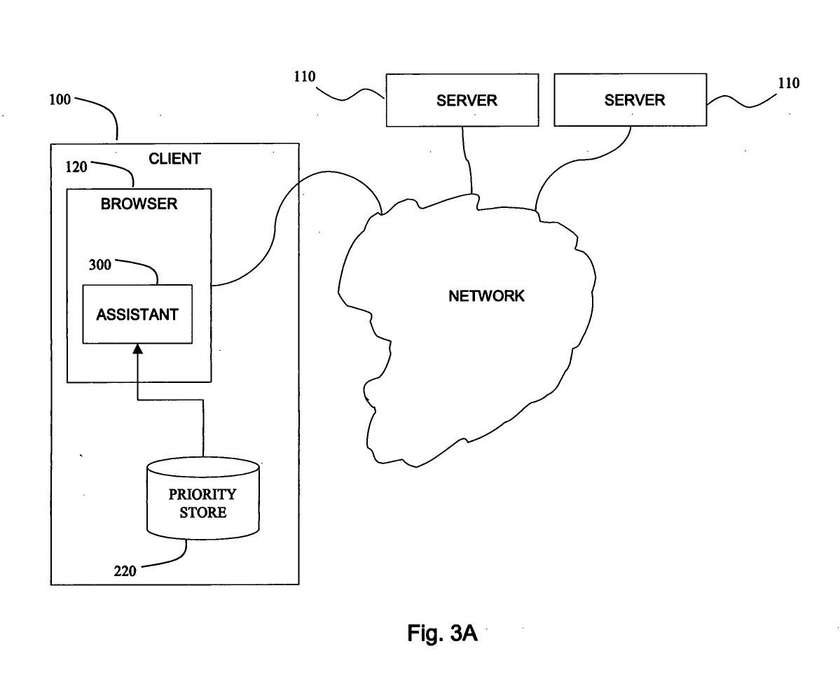

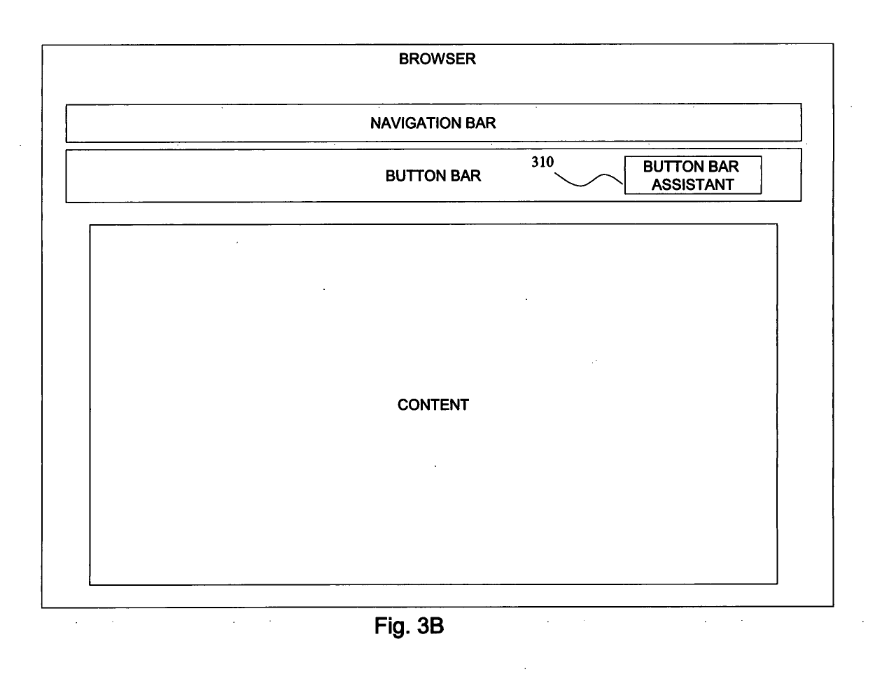

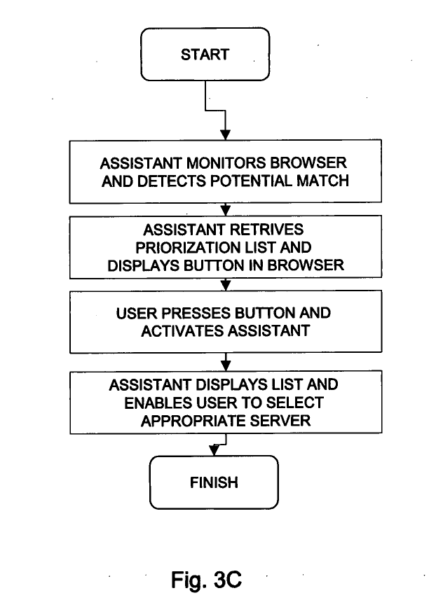

Reference is now made to FIG. 3A, which is a simplified pictorial illustration of a browsing client assistant and FIG. 3B, which is a simplified pictorial illustration of a browser display with a button bar assistant and to FIG. 3C, which is a simplified flow chart illustration of a method for providing assistance to a client browsing, operative in accordance with a preferred embodiment of the present invention. An assistant 300 preferably monitors browser 120, such as by tracking the connections and transactions of browser 120 with servers 110. The assistant 300 may employ categorizer 312 to categorize the monitored behavior and facilitate the search of priority store 220 for one or more entries that may correspond to the monitored behavior.

Continuing with the example described hereinabove in FIG. 2, should assistant 300 detect that browser 120 is retrieving content from ‘yahoo.com/news’, assistant 300 will determine, with the aid of categorizer 312, that the category associated with ‘yahoo.com/news’ is category 4000, and will search priority store 220 for all entries within category 4000, namely YahooNews and MsnNews.

Having found entries in priority store 220 in the same category as that of the monitored behavior of browser 120, assistant 300 preferably alerts a user of browser 120, such as by changing the content of a button bar assistant 310 visible in browser 120 to display, for example, a description of the category appear on button bar assistant 310. When the user presses button bar assistant 310, assistant 300 preferably retrieves records from priority store 220 from the same category as that of the currently monitored behavior, and displays the records, typically as a list of URLs and their rank. The user may then chose from the prioritized list a URL at a server 110 that may provide a desirable service.

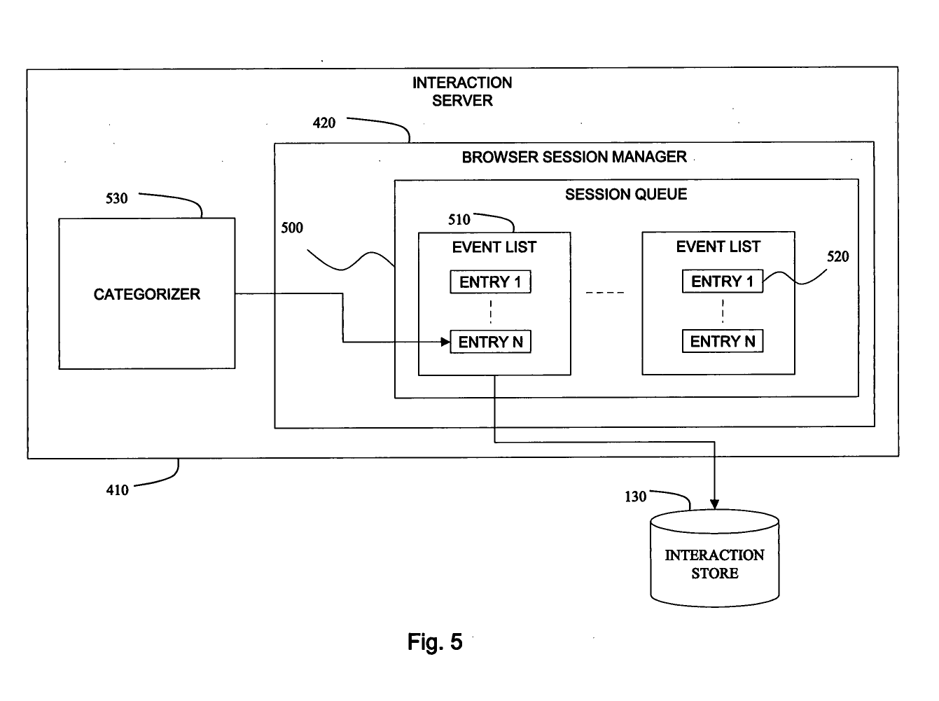

Reference is now made to FIG. 4A, which is a simplified block-flow illustration of a browser interaction monitor, constructed and operative in accordance with a preferred embodiment of the present invention. An interaction monitor 400, typically running within the execution environment of a browser 120, monitors transactions between browser 120 and server 110. Interaction monitor 400 preferably transmits to an interaction server 410 information monitored, such as an event describing the initiation of a communication channel between browser 120 and server 110, or information regarding the communication, such as the URL of the request sent by browser 120. Interaction server 410 is typically able to receive concurrent transmissions from one or more interaction monitors 400. To help identify a particular transmission, each interaction monitor 400 preferably includes a unique identifier (ID) in its transmissions to interaction server 410 that uniquely identifies the interaction monitor 400 or its respective browser 120. Interaction server 410 may utilize a browser session manager 420 to analyze the information received from interaction monitors 400 and detect the creation and destruction of virtual browser sessions, as described hereinbelow with reference to FIG. 5. Browser session manager 420 preferably records virtual browser sessions to interaction store 130 for later access by summarizer & transmitter 140, which preferably creates one or more interaction sessions during which information related to client 100's interaction with server 110 is gathered.

An example session of communication between interaction monitor 400 and interaction server 410 follow:

A user may utilize a first browser 120 to retrieve information from a first server 110 by entering a first URL, such as www.yahoo.com, on the address bar of browser 120 and pressing enter. In response, interaction monitor 400 may send the following information to interaction server 410:
event=START_BROWSING
url=www.yahoo.com
id=123456789
   Next, the user may direct a second browser 120 to retrieve information from a second server 110 by entering a second URL, such as www.msn.com, on the address bar of browser 120 and pressing enter. Subsequently, the interaction monitor 400 that is monitoring the second browser 120 may send the following information to interaction server 410:
event=START_BROWSING
url=www.msn.com
id=abcedfghi
   When the information requested by the first browser arrives, i.e. the download completes, interaction monitor 400 monitoring the first browser may send the following information to interaction server 410:
event=DOWNLOAD_COMPLETE
url=www.yahoo.com
id=123456789
   Should the user then direct the second browser 120 to a new URL that is associated with the session of the first browser 120, such as a URL in the same domain as the first browser 120 e.g. www.yahoo.com/news, the interaction monitor 400 monitoring the second browser may send the following information to interaction server 410:
event=START_BROWSING
url=www.yahoo.com/news
id=abcedfghi
   Finally, if the user closes both browsers 120, the interaction monitors 400 may send the following information to interaction server 410:
event=BROWSER_CLOSED
id=abcedfghi
event_BROWSER_CLOSED
id=123456789

Interaction server 410 may then employ browser session manager 420 to create virtual browser sessions that may be used to collect information received from the first and second interaction monitors 400 and may further include information received from other sources, such as categorization information, as described in greater detail hereinbelow with reference to FIG. 5. The browser sessions may be considered a virtual browser session as they do not necessarily correspond to a particular browser 120. Information gathered during the virtual browser session may then be stored by browser session manager 420 in interaction store 130. In the example presented above, browser session manager 420 may store the following information in interaction store 130:

| Session | Time | Event | Category | URL |
|---|---|---|---|---|
| 1 | 2/29/2004 | START_BROWSING | None | www.yahoo.com |
| | 1:07:55 | | | |
| 1 | 2/29/2004 | DOWNLOAD_COMPLETE | None | www.yahoo.com |
| | 1:09:05 | | | |
| 1 | 2/29/2004 | START_BROWSING | News | www.yahoo.com/news |
| | 1:09:55 | | | |
| 1 | 2/29/2004 | BROWSER_CLOSED | | |
| | 1:12:15 | | | |
| 2 | 2/29/2004 | START_BROWSING | None | www.msn.com |
| | 1:08:55 | | | |

Summarizer & transmitter 140 preferably retrieves at a later date the virtual browser session information from interaction store 130 and typically constructs an interaction session to gather information for transmission to aggregator 150. During the interaction session information such as the time a user spent at a particular service, i.e. the duration of a session, or the number of repeat visits the user made to the same service between sessions, may be gathered. In contrast, the virtual browser sessions are necessary to coordinate the user's behavior pattern and associate multiple instances of browser 120 with a particular service. Following the previous example, summarizer & transmitter 140 may transmit the following information to aggregator 150:

| Name | url | category | hits | duration |
|---|---|---|---|---|
| Session_1 | yahoo.com | news | 3 | 00:05:20 |
| Session_2 | msn.com | none | 1 | 00:01:00 |

Total: 2 sessions, 1 category, 4 hits, duration 6 minutes, 20 seconds

where ‘Name’ identifies a unique session, ‘Url’ identifies the browser destination, ‘category’ characterizes the nature of the interaction, ‘hits’ indicates the number of connections constructed by browser 120 to the URL, and ‘duration’ indicates the length of the interaction session.

Reference is now made to FIG. 4B, which is a simplified block-flow illustration of an aggregator with an interaction server, constructed and operative in accordance with a preferred embodiment of the present invention. The system of FIG. 4B may be understood as an alternative to the system of FIG. 4A and is substantially similar to the system of FIG. 4A with the notable exception that the interaction server 410 and the browser session manager 420 reside in aggregator 150 and communicate with aggregate server 160 and aggregate database 170. The interaction information is thus processed on aggregator 150 and not in client 100 as described in FIG. 1A and FIG. 4A.

Reference is now made to FIG. 5, which is a simplified block-flow illustration of a virtual browser session, constructed and operative in accordance with a preferred embodiment of the present invention. Browser session manager 420 preferably constructs virtual browser sessions based on the information received by interaction server 410 from interaction monitor 400. A session queue 500 may be employed to manage one or more event lists 510 that correspond to the virtual browser sessions constructed. The session queue 500 typically creates an entry 520 for the information received by interaction server 410 and may assign the entry 520 to the event list 510 that corresponds to the session previously constructed by browser session manager 420.

Throughout the course of the accumulation of browser session information from one or more browser windows accessing one or more web sites in a single session, external information may be added to an entry 520. For example, categorizer 530 may incorporate categorization information, such as the category associated with the content of a particular URL, into entry 520, utilizing any known categorization method.

Should browser session manager 420 destroy a session, session queue 500 may store the event list 510 and its corresponding entries 520 associated with the session in interaction store 130. For example, session queue 500 may save a binary representation of event list 510 to a file.

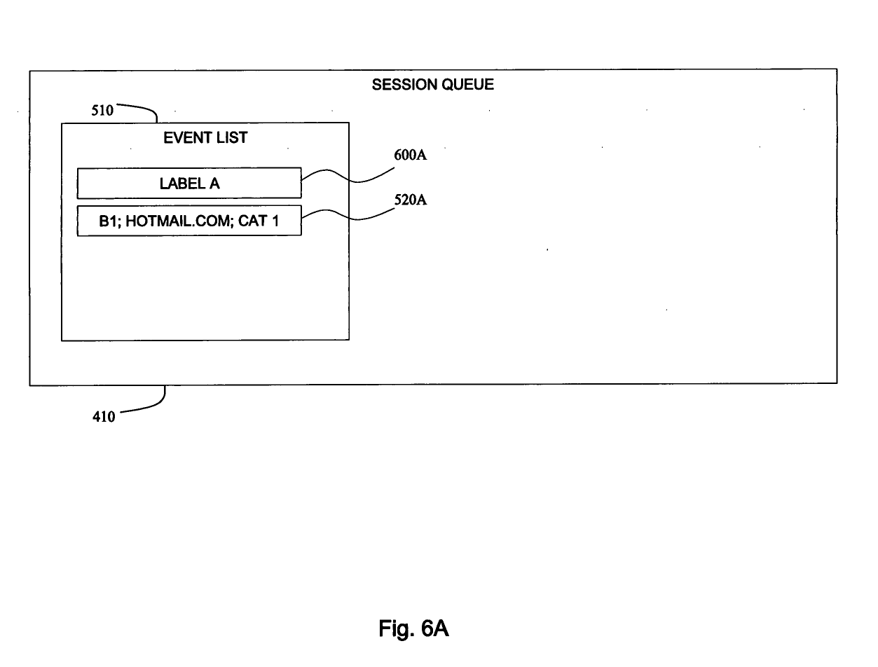

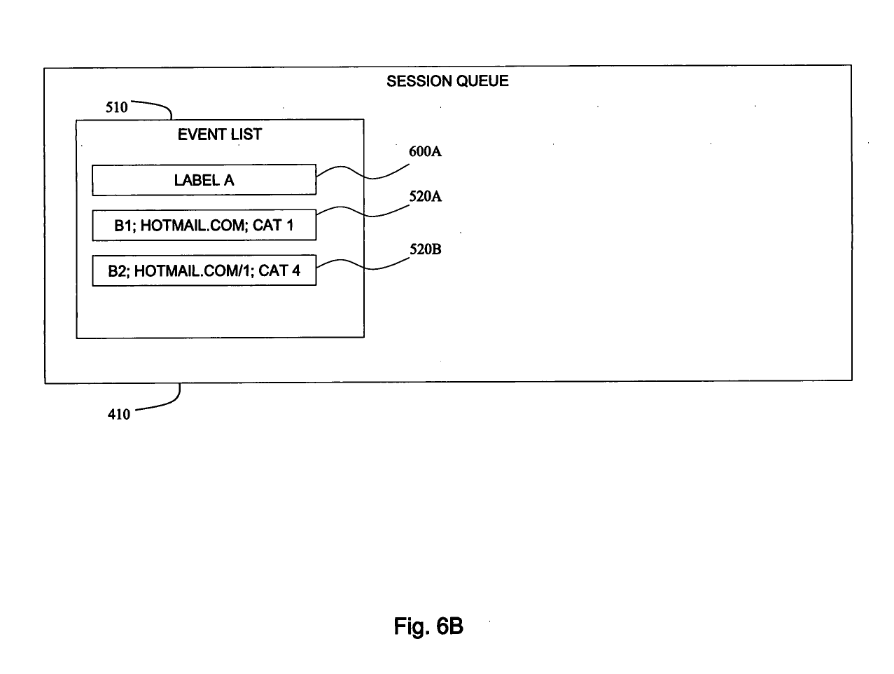

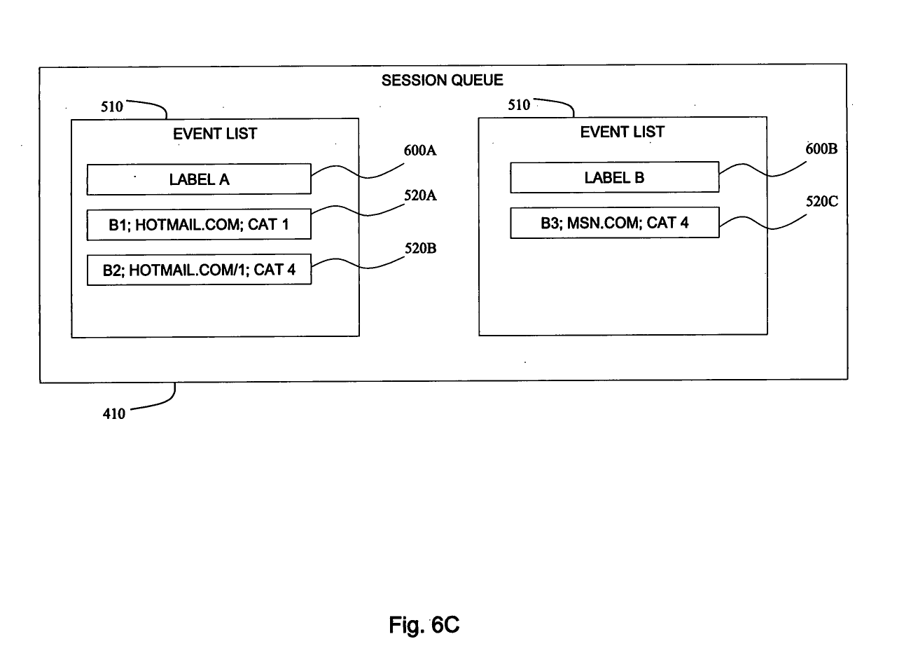

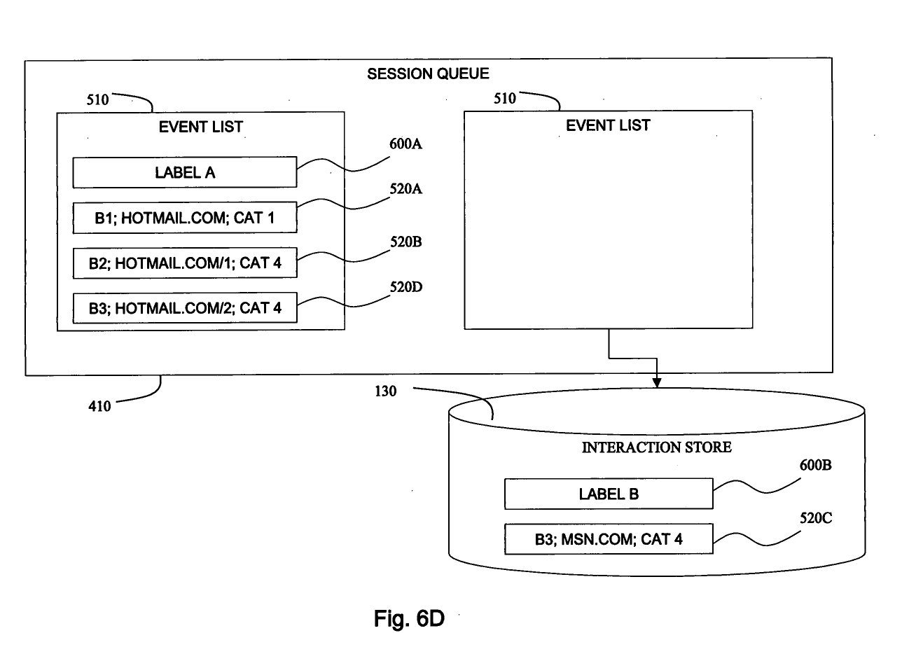

Reference is now made to FIG. 6A through 6D, which taken together are a simplified block diagrams of an exemplary session queue, constructed and operative in accordance with a preferred embodiment of the present invention. In FIGS. 6A-6D, a user opens first browser 120 (FIG. 1) and retrieves information from HOTMAIL.COM. The user's interaction is transmitted as described hereinabove to session queue 500, which creates a new event list 510 (FIG. 5) and inserts a label 600A, denoted ‘LABEL A’, into event list 510. Session queue 500 further inserts the entry ‘B1; HOTMAIL.COM’, labeled 520A, into event list 510 having ‘LABEL A’, where the string ‘B1’ identifies the browser 120 from which the interaction originated, and the string ‘HOTMAIL.COM’ identifies the URL of the interaction. Independently, categorizer 530 appends the string ‘CAT 1’ to entry 520A whose content includes ‘B1; HOTMAIL.COM’, where ‘CAT 1’ specifies the category associated with the URL in entry 520A.

The user then opens a second browser 120 and retrieves information from HOTMAIL.COM/1. The user's interaction is transmitted as described hereinabove to session queue 500, which finds an existing event list 510 associated with the URL, which in the example has the label ‘LABEL A’, and inserts into the associated event list 510 the entry ‘B2; HOTMAIL.COM/1’, labeled 520B, where the string ‘B2’ identifies the browser 120 from which the interaction originated, and the string ‘HOTMAIL.COM/1’ identifies the URL of the interaction. Independently, categorizer 530 appends the string ‘CAT 4’ to entry 520B whose content includes ‘B2; HOTMAIL.COM/1’, where ‘CAT 4’ which specifies the category associated with the URL in entry 520B.

The user then opens a third browser 120 and retrieves information from MSN.COM. The user's interaction is transmitted as described hereinabove to session queue 500, which creates a new event list 510 and inserts a label 600B, denoted ‘LABEL B’, into event list 510. Session queue 500 further inserts into event list 510 having ‘LABEL B’ the entry ‘B3; MSN.COM’, labeled 520C where the string ‘B3’ identifies the browser 120 from which the interaction originated, and the string ‘MSN.COM’ identifies the URL of the interaction. Independently, categorizer 530 appends the string ‘CAT 4’ to entry 520C whose content includes ‘B3; MSN.COM’, where ‘CAT 4’ specifies the category associated with the URL in entry 520C.

The user then directs the third browser 120 to retrieve information from HOTMAIL.COM/2. The user's interaction is transmitted as described hereinabove to the session queue 500, which calculates that none of the open browsers refer to any URLs contained within event list 510 where the label 600B is equal to ‘LABEL B’, i.e. MSN.COM. Consequently session queue 500 closes the virtual browser session associated with ‘LABEL B’, i.e. the MSN.COM session, as described hereinabove with reference to FIG. 5 and stores the event list 510 where the label 600B is equal to ‘LABEL B’ into interaction store 130. Session queue 500 further inserts into event list 510 entry 520D ‘B3; HOTMAIL.COM/2’, where the string ‘B3’ identifies the browser 120 from which the interaction originated and the string ‘HOTMAIL.COM/1’ the URL of the interaction. Independently, categorizer 530 appends to entry 520D whose content includes ‘B3; HOTMAIL.COM/2’, the string ‘CAT 4’, which specifies the category associated with the URL in entry 520D.

The virtual browser session associated with event list 510 where the label 600B is equal to ‘LABEL B’ may continue to persist throughout the lifecycle of the three open browsers 120, to be stored in interaction store 130 at a later date.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A multi-browser history aggregation system comprising:
a client computer;
a web browser with which said client is operative to selectively retrieve a web page from a server, wherein said browser is operative to monitor any interaction between said client and said server and store a description of said interaction in an interaction store;
a categorizer operative to associate said interaction with a category and store said category information in said interaction store; and
a transmitter operative to transmit previously stored interaction descriptions from said interaction store to an aggregator.

2. A system according to claim 1 and further comprising a summarizer operative to summarize said retrieved interaction descriptions.

3. A system according to claim 2 wherein said transmitter is operative to transmit said summarized information to said aggregator.

4. A system according to claim 3 wherein said aggregator is operative to rank said summarized information and store said ranking in a ranking database by category.

5. A system according to claim 1 wherein said categorizer is operative to categorize by employing a predefined mapping of potential interactions with interaction categories.

6. A system according to claim 1 and further comprising an updater operative to:
periodically retrieve said information stored in said ranking database, and store said retrieved ranking information on said client in a priority store.

7. A system according to claim 6 wherein said updater is operative to verify that the contents of said ranking database on said aggregator are different than the contents of said priority store, whereupon said updater retrieves said information stored in said ranking database.

8. A system according to claim 6 wherein said updater is operative to retrieve the latest version of said ranking database.

9. A system according to claim 1 and further comprising an assistant operative to:
monitor behavior of said browser; and
search said priority store for any entries in a category that corresponds to that of said monitored behavior.

10. A system according to claim 9 wherein said assistant is operative to provide an alert where an entry is found in said priority store that corresponds to that of said monitored behavior.

11. A system according to claim 10 wherein said assistant is operative to provide said alert by changing the content of a button bar assistant visible in said browser.

12. A system according to claim 10 wherein said assistant is operative to provide said alert by displaying a description of said found entry category appear on a button bar assistant visible in said browser.

13. A system according to claim 11 wherein said assistant is operative, responsive to a user pressing said button bar assistant, to:
retrieve said entry from said priority store from the same category as that of said currently monitored behavior, and
display said retrieved entry.

14. A system according to claim 13 wherein said assistant is operative to display said retrieved entry's URL and rank.

15. A system according to claim 1 wherein said browser comprises an interaction monitor operative to monitor said interaction between said client and said server and transmit to an interaction server said description of said interaction.

16. A system according to claim 15 wherein said interaction server is operative to receive concurrent transmissions from a plurality of said interaction monitors.

17. A system according to claim 15 wherein said interaction monitor is operative to identify any of its transmissions by including an identifier in any of its transmissions to said interaction server, wherein said identifier uniquely identifies either of said interaction monitor and said browser.

18. A system according to claim 15 and further comprising a browser session manager operative to analyze information received from said interaction monitor and detect the creation and destruction of a virtual browser session.

19. A system according to claim 18 wherein said browser session manager is operative to record a virtual browser session to said interaction store, and wherein either of said summarizer and said transmitter is operative to create an interaction session during which information related to said client's interaction with said server is gathered.

20. A system according to claim 19 wherein said browser session manager comprises a session queue operative to create an entry in an event list corresponding to said virtual browser session, said entry corresponding to said information received by said interaction server.

21. A system according to claim 20 wherein said browser session manager is operative to destroy said session, whereupon said session queue is operative to store said event list and its corresponding entries associated with said session in said interaction store.

22. A multi-browser history aggregation method comprising:
monitoring any interaction between a client and a server;
storing a description of said interaction in an interaction store;
associating said interaction with a category;
storing said category information in said interaction store; and
transmitting previously stored interaction descriptions from said interaction store to an aggregator.

23. A method according to claim 22 and further comprising summarizing said retrieved interaction descriptions.

24. A method according to claim 23 wherein said transmitting step comprises transmitting said summarized information to said aggregator.

25. A method according to claim 24 and further comprising ranking said summarized information and storing said ranking in a ranking database by category.

26. A method according to claim 22 wherein said associating step comprises categorizing by employing a predefined mapping of potential interactions with interaction categories.

27. A method according to claim 22 and further comprising:
periodically retrieving said information stored in said ranking database, and
storing said retrieved ranking information on said client in a priority store.

28. A method according to claim 27 wherein and further comprising verifying that the contents of said ranking database on said aggregator are different than the contents of said priority store, and, if so, retrieving said information stored in said ranking database.

29. A method according to claim 27 and further comprising retrieving the latest version of said ranking database.

30. A method according to claim 22 and further comprising:
monitoring behavior of said client; and
searching said priority store for any entries in a category that corresponds to that of said monitored behavior.

31. A method according to claim 30 and further comprising providing an alert where an entry is found in said priority store that corresponds to that of said monitored behavior.

32. A method according to claim 31 and further comprising providing said alert by changing the content of a button bar assistant visible in said browser.

33. A method according to claim 31 and further comprising providing said alert by displaying a description of said found entry category appear on a button bar assistant visible in said browser.

34. A method according to claim 32 and further comprising:
retrieving, responsive to a user pressing said button bar assistant, said entry from said priority store from the same category as that of said currently monitored behavior, and
displaying said retrieved entry.

35. A method according to claim 34 wherein said displaying step comprises displaying said retrieved entry's URL and rank.

36. A method according to claim 22 and further comprising monitoring said interaction between said client and said server and transmitting to an interaction server said description of said interaction.

37. A method according to claim 36 and further comprising receiving concurrent transmissions from a plurality of said interaction monitors.

38. A method according to claim 36 and further comprising identifying any of its transmissions by including an identifier in any of its transmissions to said interaction server, wherein said identifier uniquely identifies either of an interaction monitor and a browser.

39. A method according to claim 36 and further comprising detecting the creation and destruction of a virtual browser session.

40. A method according to claim 39 and further comprising recording a virtual browser session to said interaction store, and creating an interaction session during which information related to said client's interaction with said server is gathered.

41. A method according to claim 40 and further comprising creating an entry in an event list corresponding to said virtual browser session, said entry corresponding to said information received by said interaction server.

42. A method according to claim 41 and further comprising destroying said session and storing said event list and its corresponding entries associated with said session in said interaction store.
